(19) United States
(12) Patent Application Publication
(10) Pub. No.: US 2011/0231457 A1
(43) Pub. Date: Sep. 22, 2011

(54) MONITORING AND MANAGING JOB RESOURCES FOR DATABASE TASKS

(75) Inventors: Seth Tager, Oakland, CA (US); Derrill Dabkoski, Oakland, CA (US)

(73) Assignee: salesforce.com, inc., San Francisco, CA (US)

(21) Appl. No.: 13/048,753

(22) Filed: Mar. 15, 2011

Related U.S. Application Data
(60) Provisional application No. 61/314,535, filed on Mar. 16, 2010.

(51) Int. Cl. G06F 17/30

(52) U.S. Cl. 707/825; 707/E17.001

(57) ABSTRACT

Embodiments disclosed herein provide a method and systems for monitoring and managing job resources for database tasks. A database is provided, wherein the database is associated with one or more computer systems that have a plurality of resources. Each resource in the plurality of resources has a capacity limit. Resource utilization by a plurality of active jobs is monitored. A waiting job is selected for initiation from a queue of one or more waiting jobs. If one or more resources required by the selected job are not available due to capacity limitations, one or more active jobs are notified that resource permissions have been revoked. Once the resources have been released, permission is granted to the selected job to consume the one or more resources, and the selected job is initiated.

### CROSS-REFERENCES TO RELATED APPLICATIONS

The present application claims benefit under 35 USC §119(e) of U.S. provisional Application No. 61/314,535, filed on Mar. 16, 2010, entitled “QUEUE MANAGEMENT FOR LONG RUNNING JOBS SPANNING MULTIPLE TRANSACTIONS,” the content of which is incorporated herein by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present embodiments generally relates to managing data access, and more particularly to managing resources for an on-demand database and/or application service.

Typically, message queue items are processed as fast as possible without taking into account the resources consumed by each task. If a job fails, or takes a long time it can block other messages waiting to be processed. Systems can easily become overloaded because there is no mechanism for adjusting the message dequeue rate when resources are scarce, and this results in overuse of constrained resources (e.g., CPU, database connections, etc). Alternatively, where queues wait for one job to finish before starting the next job, resources may sit idle (i.e., go to waste) if a particular job cannot take advantage of all the available resources, causing job throughput to degrade.

Accordingly, it is desirable to provide systems and methods that overcome or at least partially alleviate the above problems and others.

Reference to the remaining portions of the specification, including the drawings and claims, will realize other features and advantages of the present embodiments. Further features and advantages of the present embodiments, as well as the structure and operation of various embodiments, are described in detail below with respect to the accompanying drawings. In the drawings, like reference numbers indicate identical or functionally similar elements.

BRIEF SUMMARY

Embodiments disclosed herein provide a method and systems for monitoring and managing job resources for database tasks. A database is provided, wherein the database is associated with one or more computer systems that have a plurality of resources. Each resource in the plurality of resources has a capacity limit. Resource utilization by a plurality of active jobs is monitored. A waiting job is selected for initiation from a queue of one or more waiting jobs. If one or more resources required by the selected job are not available due to capacity limitations, one or more active jobs are notified that resource permissions have been revoked. Once the resources have been released, permission is granted to the selected job to consume the one or more resources, and the selected job is initiated.

In some embodiments, attributes of a job may comprise an associated database task, a priority, and a minimum number of resources required by the job. Attributes of an active job may further comprise a number of resources currently being consumed by the job and a length of time that the job has been running Attributes of a waiting job may further comprise a length of time that the job has been waiting to start.

In one embodiment, the determination as to which job to select for initiation from the queue of one or more waiting jobs is based on attributes of one or more jobs in the queue of one or more waiting jobs, attributes of one or more jobs in the plurality of active jobs, and the capacity limit for each resource in the minimum number of resources required by the job.

In one embodiment, the determination that resource permissions for a particular active job should be revoked is based on attributes of one or more jobs in the queue of one or more waiting jobs, attributes of one or more jobs in the plurality of active jobs, and the capacity limit for each resource in the minimum number of resources required by the job.

In one embodiment, at least one of the one or more active jobs in the plurality of active jobs are interrupted so that resources associated with the permissions can be released.

In one embodiment, a determination is made as to whether resources have been released for at least one of the one or more notified active jobs. In one embodiments, a determination is made that surplus resources are available. For a particular active job that released resources and yet is not complete, a determination is made as to whether the particular active job requires additional resources - if so, then the required additional resources are granted to the particular active job. In one embodiment, the selection of which active job is to be granted additional resources is based on attributes of one or more jobs in the queue of one or more waiting jobs, attributes of one or more jobs in the plurality of active jobs, and the capacity limit for each resource in the minimum number of resources required by the job.

In one embodiment, information identifying the plurality of active jobs that are currently running is stored in persistent storage. In one embodiment, a system restart is detected, and information identifying a plurality of active jobs that were running prior to the system restart is retrieved. For each job in the plurality of active jobs that were running prior to the system restart, permission to consume the one or more resources required by that job is granted, and the job is resumed.

In one embodiment, notifying an active job that resource permissions have been revoked comprises notifying the active job that permissions for particular resources have been revoked, wherein the active job is able to continue running without using the particular resources. If the job is not able to complete its associated database task, the job may be placed in the queue of one or more jobs waiting to run once it is no longer able to continue running

In one embodiment, the plurality of active jobs are polled to detect jobs that are no longer utilizing resources for which they have permission. If a job is found to be no longer utilizing the resources for which it has permission, the job is notified that permission for the resources that are no longer being utilized has been revoked. Once a notification is received from the job that the resources have been released, the job is stopped.

In one embodiment, a notification is received that the plurality of resources associated with the one or more computer systems have been re-configured, and resource permissions are re- distributed amongst jobs in the plurality of active jobs. Particular jobs may be notified that their resource permissions have been revoked.

Other embodiments are directed to systems and computer-readable media associated with methods described herein.

While the present embodiments are described with reference to an embodiment in which techniques for reducing database downtime in an on-demand services environment are implemented in a system including a single source database and a single target database, the present embodiments are not so limited. In addition, embodiments may be practiced using other database architectures, i.e., ORACLE®, DB2® by IBM and the like without departing from the scope of the embodiments claimed.

Any of the above embodiments may be used alone or together with one another in any combination. Embodiments encompassed within this specification may also include those that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings, like reference numbers are used to refer to like elements. Although the following figures depict various example embodiments, the embodiments are not limited to the examples depicted in the figures.

FIG. 1 illustrates a block diagram of an environment wherein an on-demand database service might be used.

FIG. 2 illustrates a block diagram of an embodiment of elements of FIG. 1 and various possible interconnections between these elements according to one embodiment.

FIG. 3 is a diagram illustrating the flow of interaction among objects in certain embodiments, wherein the interaction is related to dequeue operations.

FIG. 4 is a diagram illustrating the flow of interaction among objects in certain embodiments, wherein the interaction is related to restart and initialization.

FIG. 5 is a diagram illustrating the flow of interaction among objects in certain embodiments, wherein the interaction is related to releasing and re-distributing resources.

FIG. 6 is a diagram illustrating the flow of interaction among objects in certain embodiments, wherein the interaction is related to monitoring resource utilization.

### DETAILED DESCRIPTION

The present embodiments provide systems and methods for managing resources in an on-demand database and/or application service.

As used herein, the term multi-tenant database system refers to those systems in which various elements of hardware and software of the database system may be shared by one or more customers. For example, a given application server (e g , running an application process) may simultaneously process requests for a great number of customers, and a given database table may store rows for a potentially much greater number of customers. As used herein, the term query or query plan refers to a set of steps used to access information in a database system.

### System Overview

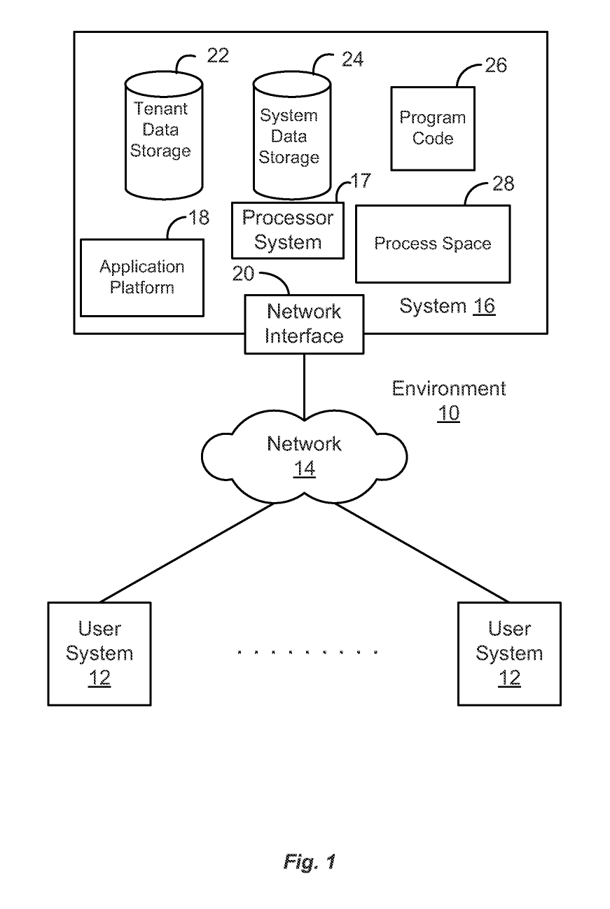

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

Environment 10 is an environment in which an on-demand database service exists. User system 12 may be any machine or system that is used by a user to access a database user system.

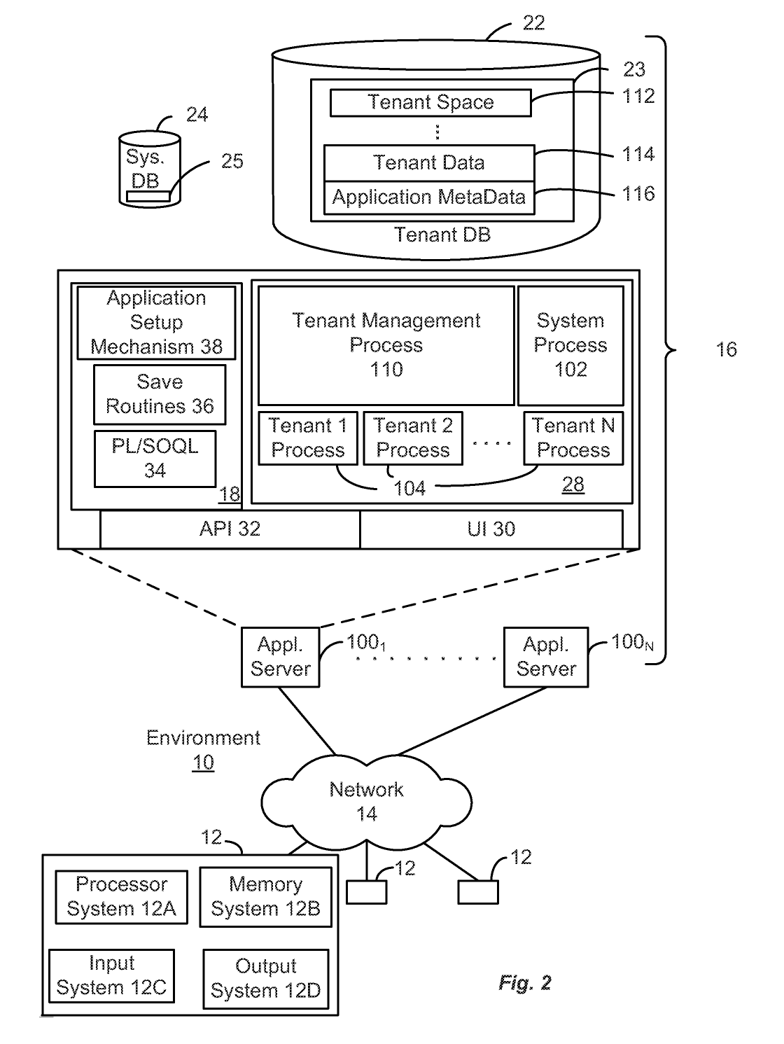

For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and

Internet Protocol) network, such as the global internetwork of networks often referred to as the “Internet” with a capital “I,” that network will be used in many of the examples herein. However, it should be understood that the networks that the present embodiments might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications (application processes) as well as provide related data, code, forms, web pages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol

(WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of a MTS, where more than one is present) and all of their components might be operator configurable using application(s) including computer code to run using a central processing unit such as processor system 17, which may include an Intel Pentium® processor or the like, and/or multiple processor units. A computer program product embodiment includes a non-transitory machine-readable storage medium (media) having instructions stored thereon/in which can be used to program a computer to perform any of the processes of the embodiments described herein. Computer code for operating and configuring system 16 to intercommunicate and to process web pages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, JavaTM, JavaScript, ActiveX, any other scripting language, such as VBScript, and many other programming languages as are well known may be used. (JavaTM is a trademark of Sun Microsystems, Inc.).

According to one embodiment, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more OracleTM databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N}-₁ might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because a MTS might support multiple tenants including possible competitors, the MTS should have security protocols that keep data, applications, and application use separate. Also, because many tenants may opt for access to a MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24.

System 16 (e.g., an application server 100 in system 16) automatically generates one or more SQL statements (e.g., one or more SQL queries) that are designed to access the desired information. System data storage 24 may generate query plans to access the requested data from the database.

A table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. Yet another table or object might describe an Opportunity, including fields such as organization, period, forecast type, user, territory, etc.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system.

### Queue Management

Data copying and database migration tasks may be executed in such a way that if many copy jobs are initiated at once, the database server(s) involved become crippled due to intense consumption of and competition for resources. In these cases, there may be no mechanism for adjusting the number of resources used by the various running jobs. These issues may arise with respect to any system resource whose capacity may be saturated when the system simultaneously executes many jobs associated with database tasks, e.g., threads, database connections, locks, I/O ports, CPU processing units, file handles, blocks of memory, and network bandwidth.

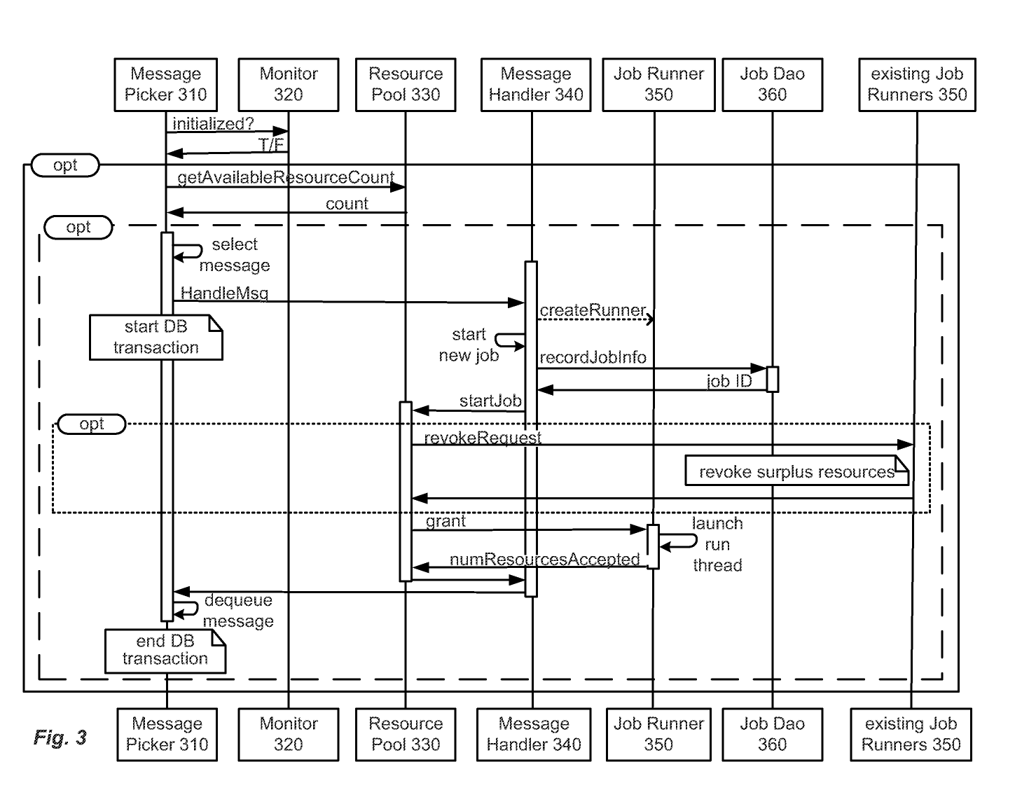

FIGS. 3-6 illustrate a framework for monitoring and managing job resources for database tasks. One goal of this framework is to specify a way to monitor and manage jobs by requiring that permission be granted before any job can utilize a resource, e.g., creating a thread, or initiating a database connection, and by enabling dynamic adjustment of resource utilization via revocation and/or re-assignment of resource permissions. Another goal is to maximize efficient utilization of system resources by distributing resource permissions to jobs based on one or more factors, which may include the type of database task associated with the job, the priority of the job, the minimum number of resources required by the job, the length of time that the job has been running or waiting, the types of resources required by the job, etc. Another goal is to ensure that jobs that require large numbers of resources are not starved for excessive length of time because the minimum number of resources required by the job is difficult to attain. Another goal is to enable detection of a stalled or frozen job that is holding onto resources, whereupon the permissions for those resources can be revoked and the resources re-distributed. Another goal is to enable detection of a job that has somehow lost a resource for which it had permissions, whereupon the resources can be re-acquired or the job can be stopped and/or restarted. Another goal is to provide a way to re-establish the framework in case of a system restart, whether voluntary or involuntary.

Attributes of a job may comprise an associated database task, a priority, and a minimum number of resources required by the job. Attributes of an active job may include a number of resources currently being consumed by the job and a length of time that the job has been running Attributes of a waiting job may include a length of time that the job has been waiting to start.

Priority of a job may be based on any number of factors, possibly including: a deadline to complete a particular database task, the status or identity of the owner or requester of the database task, administratively-assigned priority ranking, etc.

### Dequeuing Messages and Handling Jobs

One main function of the framework for monitoring and managing job resources for database tasks is the process of dequeuing messages from the message queue and admitting queued- up jobs into the framework. In one embodiment, a message queue is used to queue up messages that represent job requests (i.e., jobs waiting to be granted resource permissions and initiated). A job is initiated after its associated request is pulled off the queue. All information required to run a specific job may be included in the message that is added to the message queue. This information may be stored in a collection of name/value pairs (e.g., MessageParameter instance). Such information may include the enqueue timestamp (used to determine how long a job has been waiting in the queue), the job type (used to instantiate a JobRunner), the associated database task, the minimum number of resources required to run the job, along with any other information that is required or helpful for the specific type of job being run.

Each job may have a minimum number of resources that is required before the associated request is admitted to the queue. If that minimum number of resources does not become available, the job may be left in the queue until enough resources become available. Jobs are generally admitted on a first-come, first-served basis, but priorities can be used to allow certain jobs to jump to the front of the queue.

FIG. 3 is a diagram illustrating the flow of interaction among objects, wherein the interaction is related to dequeue operations. Solid lines indicate flow of control from one object to another. Dashed lines indicate the creation of the object to which the line points.

MessagePicker 310 checks with Monitor 320 to see whether the framework has been initialized. If the system crashes, for whatever reason, it is important to restart the system in the same state it was in when it went down. Monitor 320 may be responsible for restarting those jobs.

When the system starts up, Monitor 320′s initialized flag is set to false. As part of the system start up process Monitor 320 may be called to initialize the system. After Monitor 320 restarts jobs that were previously running before the system restart, Monitor 320 sets its initialized flag to true, and the system is ready to handle new messages. If Monitor 320′s initialized flat is set to false, then MessagePicker 310 may exit without choosing any messages; if it returns a true value, MessagePicker 310 may continue by selecting a message from the queue.

In some embodiments, MessagePicker 310 may also be responsible for managing a single database transaction that is used to perform all database communication during the dequeue process. A single transaction ensures that all database work that happens during dequeue is committed at the end of the dequeue sequence, after the message itself is marked as dequeued. If an exception is thrown at any point during dequeuing then the entire transaction may be rolled back so that the system returns to the state it was in before dequeuing began.

ResourcePool 330 knows the total number of resources it controls and monitors currently running/active jobs. ResourcePool 330 maintains information about the currently running/active jobs including the minimum number of resources required for that job, the number of resources that are promised to each job, and the number of resources that are granted to each job. From this information ResourcePool 330 can calculate:

the number of free resources (total resources less the sum of all promised resources),

the number of available resources (total resources less the sum of all minimum resources required to start each of the currently running/active jobs), and

the number of surplus resources being used (sum of all promised resources less the sum of all minimum resources required to start each of the currently running/active jobs).

In one embodiment, if Monitor 320 indicates that the system has been initialized, MessagePicker 310 calls on ResourcePool 330 in order to obtain the total number of resources that are available for starting new jobs (i.e., the “count”). In one embodiment, MessagePicker 310 must obtain a lock on ResourcePool 330 before obtaining the count of available resources in order to ensure that the same number of resources continue to be available during handling of the message and subsequent dequeuing of the message.

MessagePicker 310 may check this number against the minimum required for each job in the queue. Each job may contain metadata which includes a minimum number of resource that it requires to begin processing. If any job requires the same or fewer resources as are available then that job can be started. MessagePicker 310 determines whether any messages on the queue can be initiated. In one embodiment, MessagePicker 310 selects a message from the queue and checks to see if enough resources are available to start the job; if sufficient resources are not available to start that job, the next job is evaluated. In one embodiment, MessagePicker 310 looks at jobs in order based on how old the job is (e.g., oldest first) or based on which job has the highest priority ranking

In one embodiment, the selection is based on attributes of one or more jobs in the queue of one or more waiting jobs, attributes of one or more jobs in the plurality of active jobs, and/or the capacity limit for each resource in the minimum number of resources required by the job. If there are not sufficient resources available for any jobs to start, then MessagePicker 310 may exit and wait some amount of time before checking again.

In some embodiments, if there are older messages in the queue that require more resources than are available, MessagePicker 310 has the option to handle those messages, or wait for more resources to become available, in favor of starting newer messages that require fewer resources. Many small jobs could continually eat up small numbers of available resources in a way that the system never recovers enough resources to start large jobs. In some embodiments, MessagePicker 310 provides some assurance that old jobs are not starved forever (the criteria for making that decision may be different for different message queues).

In one embodiment, if MessagePicker 310 finds that there are enough resources available to select a message associated with a job, it calls on MessageHandler 340—this is a class that knows how to start a specific type of job. MessagePicker 310 calls on MessageHandler 340 to handle the message, which is responsible for performing any work required to start the job described by the message.

In one embodiment, MessageHandler 340 instantiates a new JobRunner 350. JobRunner 350 is responsible for executing the job—amongst other tasks, it may request, acquire, retain, and release resource permissions, as well as resources in order to run a job. A message may contain the name of the class needed to process the message. Introspection may be used to create a JobRunner 350 based on information contained in the message.

In one embodiment, MessageHandler 340 then starts a new job in association with the new JobRunner 350. The message parameters (e.g., MessageParameter instance) may specify information needed to instantiate new job—when MessageHandler 340 creates new job, all of that information may be transferred to new job.

JobDao (i.e., Job Data Access Object) 360 is a class that knows how to store and retrieve Jobs to and from long-term storage. Long-term storage must be able to survive a server crash. The stored information may then be used to restart jobs that may have been running when the system crashed.

In one embodiment, MessageHandler 340 commits new job to long-term storage (e.g., persistent storage) by calling on JobDao 360 to record information about new job (e.g., the MessageParameters). This call writes the job information to the database but does not commit it. The commit happens later after MessagePicker 310 dequeues the message. JobDao 360 may create a unique job ID for new job and return that job ID to MessageHandler 340. The job ID can be used later to retrieve information for new job from the database.

Next, MessageHandler 340 calls on ResourcePool 330 to help start the new job by providing resource permissions. ResourcePool 330 is responsible for distribution of resource permissions to Job Runners 350. If the minimum number of resources required to start new job is greater than the number of free resources, then ResourcePool 330 may need to interrupt some currently active jobs in order to obtain the required resources. This may comprise notifying one or more existing JobRunners 350 (which are associated with currently active jobs) that resource permissions have been revoked if they are currently retaining permissions for surplus resources. The number of surplus resources may be defined as the total number of resources in the pool less the total number of minimum resources required by all currently-running jobs.

The determination regarding which currently active jobs should be selected for revocation of resource permissions may be based on attributes of one or more jobs in the queue of one or more waiting jobs, attributes of one or more jobs in the plurality of active jobs, and/or the capacity limit for each resource in the minimum number of resources required by the job. In one embodiment, the most-recently started jobs are selected for revocation first. In some embodiments, the determination may be based upon whether or not a job is able to continue running, at least for some time, without using the resources for which permissions are to be revoked. In some embodiments, a job that was selected on the basis of being able to continue running without the resources may reach a point at which it is no longer able to continue without the resources—at this point, it may be placed in the queue of waiting jobs.

If ResourcePool 330 determines that it needs to recover surplus resources in order to start new job, it may call on existing JobRunners 350, associated with one or more currently active jobs that are using surplus resources, in order to revoke permissions for a sufficient number of resources to start new job. In one embodiment, the currently active job does not have to give up the resource immediately, although it may do so at the earliest convenient time. (In one embodiment wherein the resource comprises a thread, the currently active job may have the option of keeping track of the request and calling back to the thread pool in another thread after it is able to release the resource gracefully.) In one embodiment, each existing JobRunner 350 notifies ResourcePool 330 as to the number of resources that it is able to release immediately (which may be zero).

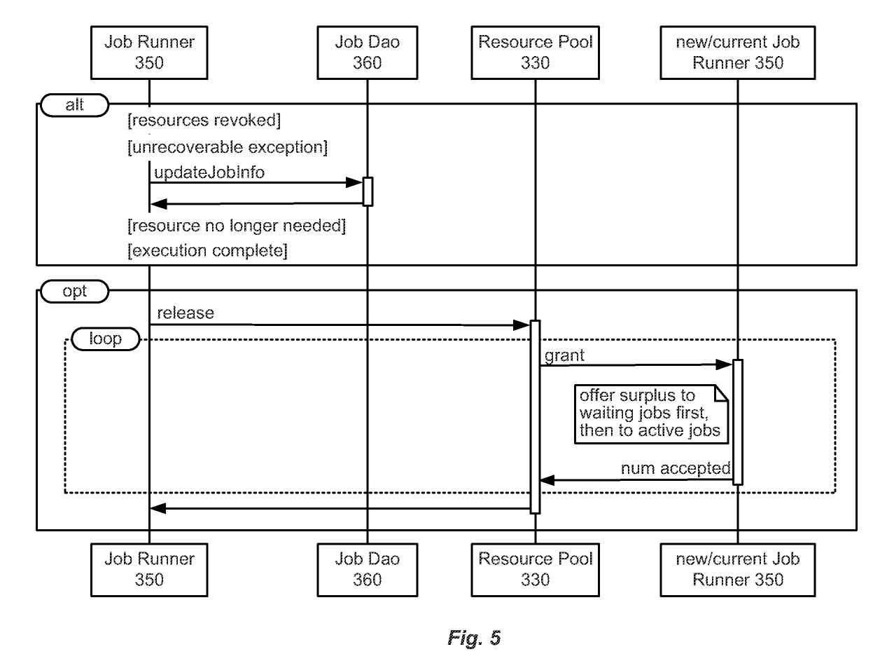

In one embodiment, ResourcePool 330 then notifies the new JobRunner 350 that a given number of resources are available for immediate consumption and that resource permissions for the resources have been granted. The number of resources that are available for immediate consumption may be smaller than the minimum required if other jobs are still using surplus resources. See FIG. 5 and related portions of the specification for more information on how remaining resources are granted to new jobs. The new JobRunner 350 may immediately start to use the number of resources granted, or it may choose not to use that number of resources at all.

In one embodiment, the new JobRunner 350 launches a thread to utilize the resources. The new JobRunner 350 may launch other threads to perform the work required to complete the new job, as opposed to running the new job in the current thread.

The new JobRunner 350 may return the number of resources that were accepted by the new job (this may be anything from zero up to the maximum number of resources that were offered to the new job). In one embodiment, any resources that were accepted by the new JobRunner 350 are now considered to be “in use” by the new job and must be released (possibly in response to a notification of revocation) before they can be used by a different job.

At this point the message has been handled to completion, and MessagePicker 310 can dequeue the message by submitting a request to the database to mark the message as having been handled. In one embodiment, MessagePicker 310 now ends the database transaction, and all database activity that occurred during the handling and dequeuing of the message is committed to the database. If any failures occur during handling of the message, then all database request made during the handling of the message may be rolled back so that the system returns to the state it was in before this message was handled.

Some types of exceptions can indicate that there is a fatal problem with the message. Message queues and error handling are well-known in the art—conventional message queue and error-handling technologies may be utilized in conjunction with the embodiments disclosed herein.

In some embodiments, multiple queues may be used—each controlling a fixed number of resources. In other embodiments, a single queue is used where only one job can be run at a time.

In one embodiment, instead of implementing a dequeue mechanism that is sensitive to load, a user interface providing a simple capacity-driven metering facility is provided that can be placed in the hands of systems administrators and used when necessary. Therefore, in certain embodiments:

1. The unit of capacity is one thread.

2. Job size (in number of resources used) is configured based on the organization size, in disjoint ranges.

3. In order to prevent the starvation of small jobs by large jobs, the minimum capacity is the sum of the number of resources used for one job of every expressed size range.

4. In order to prevent the starvation of large jobs by small jobs, a maximum age of a job will be supplied in units of hours—if there is an aged job on the queue, no jobs will be dequeued until there is capacity to take the aged job, at which point it will be dequeued, and normal processing will resume.

5. A threshold for organization size in megabytes is used to determine, for certain jobs, whether the job will use flashback queries.

6. Capacity is metered per database server node.

In one embodiment, the user interface allows for the following input to be entered:

1. Capacity in threads, at least sum of the number of threads used for each size range.

2. Maximum age for a job before its forced in front of other jobs, e.g., in hours.

3. Threshold for the flashback queries in gigabytes.

In certain aspects, the UI may provide the ability to modify the ranges and thread counts of the job map.

### Restart and Initialization

Another primary function of the framework for monitoring and managing job resources for database tasks is the process of handling server restarts and initialization. The server may be shut down abruptly or may crash occasionally for a variety of reasons. When this happens all jobs in progress are interrupted and need to be resumed upon server restart. Server start-up and initialization may occur upon start-up after the server crashes. The goal is to restore the state of all jobs that were running when the system shut down, and to reallocate resources to those jobs before any newer jobs are dequeued.

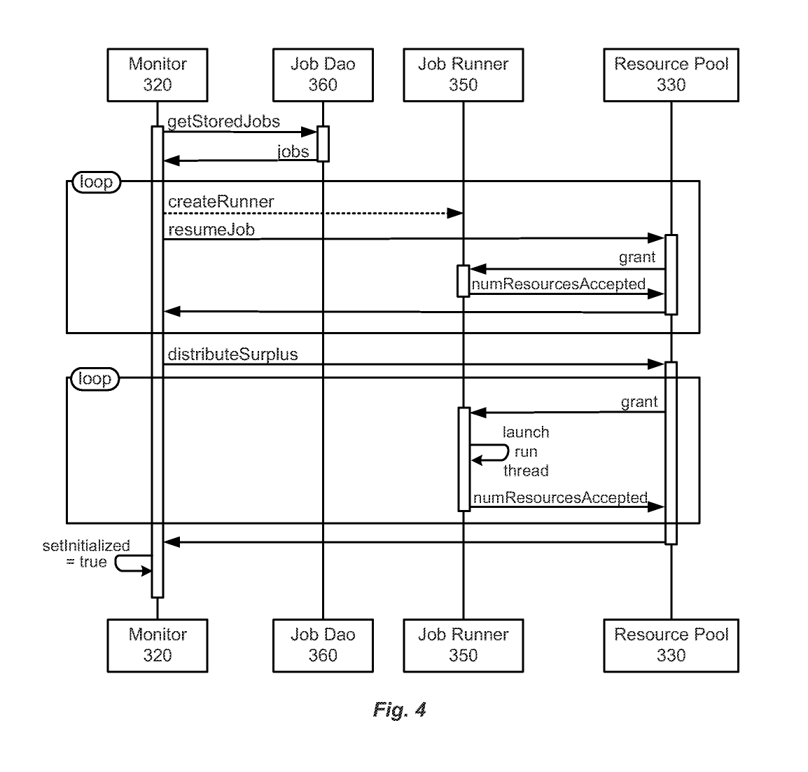

FIG. 4 is a diagram illustrating the flow of interaction among objects, wherein the interaction is related to restart and initialization. In one embodiment, when a system restart has been detected, Monitor 320 calls on JobDao 360 to fetch all previously-running jobs from long-term storage, and JobDao 360 returns a collection of jobs. In one embodiment, the collection of jobs comprises sufficient job information (e.g., MessageParameters) to resume each job.

In one embodiment, the framework then loops over the collection of previously-running jobs—these are all of the jobs that were running when the system shut down. For each job to be resumed,

1. Monitor 320 creates a new JobRunner 350, which is to be responsible for executing the job and managing resources for the job.

2. Monitor 320 calls on ResourcePool 330 in order obtain new resource permissions needed to resume the job.

3. ResourcePool 330 grants resource permissions for the job's minimum required resources to the newly-created JobRunner 350.

4. JobRunner 350 may not be ready to use the granted resources. It may accept only some or all of the resource permissions. It may return the total number of resource permissions that it accepted.

In one embodiment, if there are resources still available after allocating the minimum for each job, surplus resources are distributed amongst the resumed jobs. Surplus resources may be offered to the oldest job first. If that job declines to consume the resources then they may be offered to the next oldest job. In this manner, completion of the oldest jobs first is prioritized. In another embodiment, surplus resources are offered to jobs with the highest priority level first.

In one embodiment, Monitor 320 calls on ResourcePool 330 to distribute permissions for surplus resources to currently active jobs. Resource permissions may be offered in a particular order, e.g., from oldest to newest, or in some other order of priority.

1. ResourcePool 330 notifies another JobRunner 350 that a given number of surplus resources are available for immediate consumption.

2. JobRunner 350 accepts permissions for some number of resources and obtains the resources (e.g., threads) to perform the database task associated with the job.

3. JobRunner 350 returns the number of resources that it accepted.

In one embodiment, now that all jobs are running again, and the values recorded in ResourcePool are correct, initialization is complete and the initialized flag for Monitor 320 is set to true. After this flag is set to true the message queues may begin dequeuing and handling new messages. This ensures that newer jobs are not started until previously running jobs have been restarted.

In one embodiment, system resources may have been reconfigured during the restart. In the case where additional resources were added, ResourcePool 330 may go through the set of currently active jobs to determine if permission for surplus resources should be granted to any currently active jobs; ResourcePool 330 may also go through the queue of waiting jobs to determine which jobs can and should be granted resource permissions and initiated. In the case where resources have been reduced relative to the previous configuration, ResourcePool 330 may go through the set of currently active jobs to select which currently active jobs for which to revoke resource permissions, and notify the selected jobs of the revocation.

### Redistributing Resources

The framework attempts to make maximal use of all resources in the pool. In order to do this, a job may be allowed to use more resources than the minimum required by that job. This means that sometimes jobs may be using resources that are needed to start other jobs. When that happens the ResourcePool may revoke resources from one or more of the jobs that are using surplus resources in order to redistribute resources to jobs that require them. At other times the jobs themselves may determine that they no longer need a particular resource and release it.

FIG. 5 is a diagram illustrating the flow of interaction among objects, wherein the interaction is related to releasing and re-distributing resources. This figure demonstrates the process of transferring resource usage from one job to another.

There may be several scenarios under which a JobRunner 350 may release resources:

JobRunner 350 detects that resources have been revoked: during the course of executing a long-running job, JobRunner 350 may periodically check to see if resource permissions have been revoked. JobRunner 350 may keep track of resource permissions that were revoked since the last time 350 JobRunner checked on its resource permissions.

JobRunner 350 detects an unrecoverable exception: JobRunner 350 may detect an unrecoverable error, which may need to record the error before releasing resources.

JobRunner 350 may call on JobDao to update information for the job with information about the exception or error. Such information may need to be recorded to allow for diagnosis of problems by tech support at some time in the future.

JobRunner 350 may detect that some or all resources are no longer needed to complete the job.

JobRunner 350 completes its associated database task or step thereof

All of the alternatives may be controlled by the job state, which may be detected by JobRunner 350 in the normal course of executing the job. If any of the above alternative scenarios occurs (or any other event that frees up a resource being used by JobRunner 350), the following sequence may be invoked:

1. The releasing JobRunner 350 notifies ResourcePool 330 that it has released some number of resources.

2. ResourcePool 330 may then offer the surplus resources to jobs waiting in the queue until the surplus is distributed as completely as is possible—this loop is performed over all messages in the queue. See FIG. 3 and associated sections for more detail.

3. If there are still surplus resources available, ResourcePool 330 then offers surplus resources to one or more currently active jobs until the surplus is completely distributed. See FIG. 4 and associated sections for more detail.

4. Both new JobRunners 350 and existing JobRunners 350 return the number of resources that were accepted (they may not be able to use all of the resources granted)—so that ResourcePool 330 knows if surplus resources remain available.

### Monitoring Resource Utilization

Some jobs that are dependent upon external processes may require a polling mechanism to detect when the job is complete or when an error is encountered.

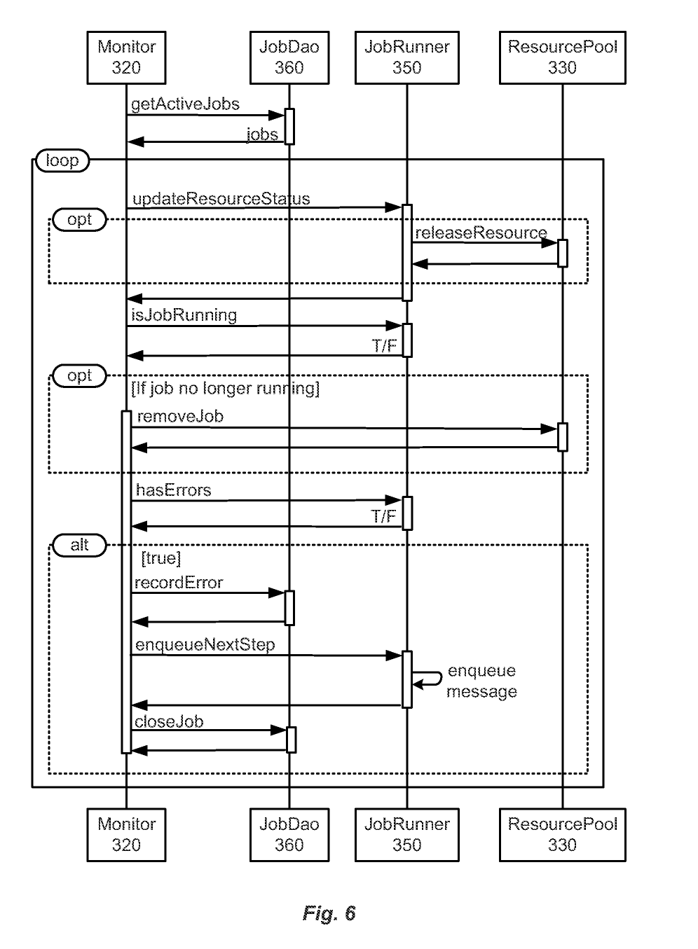

FIG. 6 is a diagram illustrating the flow of interaction among objects, wherein the interaction is related to monitoring resource utilization. FIG. 6 describes how jobs are monitored and what are the steps for shutting down completed jobs.

Monitor 320 may call on JobDao 360 in order to retrieve the list of currently-running jobs from the database. After JobDao 360 returns the list of jobs, the framework may then poll all of the currently-running jobs by looping through the following steps for each job in the list:

1. Monitor 320 calls on the JobRunner 350 associated with the job to update its resource status: the running job checks on the resources that it is currently using and determines whether any of those resources are no longer being used. This may also be an opportunity for JobRunner 350 to detect and restart an abnormally-terminated job and then update resource utilization.

2. If JobRunner 350 detects that one or more resources are no longer required, it may release the resource(s) and notify ResourcePool 330 that resources have been released.

3. Monitor 320 calls on JobRunner 350 to determine job status: JobRunner 350 may need to detect whether the job is still running A job that is no longer running (e.g., due to either an exception or normal job completion) should not be holding on to any resources. However, a job that is not currently holding any resources may still be running and may be able to use resources for which permissions are granted in the future.

4. If the job has terminated, Monitor 320 calls on ResourcePool 330 to remove the job from the list of currently active jobs. The job will no longer be tracked by ResourcePool 330. The job will not be granted permissions for any more resources, and any resource permissions it had will be revoked in order to force the job to release any resources that it is still holding on to.

5. Monitor 320 calls on JobRunner 350 to determine whether there were errors that prevented the job from completing normally. JobRunner 350 may be required to retain records when a job terminates abnormally.

6. If there were errors that prevented the job from completing normally, Monitor 320 calls on JobDao 360 to record information about the errors to long-term storage.

7. If there were no errors, processing is complete for single-step database tasks. However, for multi-step database tasks, Monitor 320 calls on JobRunner 350 to enqueue the next job to be executed for the database task onto the message queue of waiting jobs. Different steps in a database task may be handled by completely independent jobs.

8. JobRunner 350 enqueues a message to the queue of waiting jobs with enough information to carry out the next job in the task.

9. Monitor 320 calls on JobDao 360 to close the job by cleaning up associated records and removing it from the collection of currently-running jobs.

While the invention has been described by way of example and in terms of the specific embodiments, it is to be understood that the invention is not limited to the disclosed embodiments.

To the contrary, it is intended to cover various modifications and similar arrangements as would be apparent to those skilled in the art. Therefore, the scope of the appended claims should be accorded the broadest interpretation so as to encompass all such modifications and similar arrangements.

1. A method of monitoring and managing job resources for database tasks, the method comprising:
providing a database, wherein the database is associated with one or more computer systems, wherein the one or more computer systems are associated with a plurality of resources, and wherein each resource in the plurality of resources has a capacity limit;
monitoring a plurality of active jobs, wherein attributes of an active job comprise an associated database task, a priority, a minimum number of resources required by the job, a number of resources currently being consumed by the job, and a length of time that the job has been running;
selecting, using one or more processors associated with the one or more computer systems, a job to initiate from a queue of one or more waiting jobs, wherein attributes of a waiting job comprise an associated database task, a priority, a minimum number of resources required by the job, and a length of time that the job has been waiting to start;
determining, using the one or more processors associated with the one or more computer systems, that one or more resources of the one or more computer systems required by the selected job is not available due to a capacity limit of the at least one resource;
notifying one or more active jobs in the plurality of active jobs that resource permissions have been revoked, wherein the resource permissions are associated with the one or more resources required by the selected job;
granting permission to the selected job to consume the one or more resources required by the selected job; and
initiating the selected job.

2. The method of claim 1, further comprising determining that a particular job from the queue of one or more waiting jobs should be selected for initiation based on attributes of one or more jobs in the queue of one or more waiting jobs, attributes of one or more jobs in the plurality of active jobs, and the capacity limit for each resource in the minimum number of resources required by the job.

3. The method of claim 1, further comprising determining that resource permissions for a particular active job should be revoked based on attributes of one or more jobs in the queue of one or more waiting jobs, attributes of one or more jobs in the plurality of active jobs, and the capacity limit for each resource in the minimum number of resources required by the job.

4. The method of claim 1, further comprising interrupting at least one of the one or more active jobs in the plurality of active jobs so that resources associated with the permissions can be released.

5. The method of claim 1, further comprising determining that resources have been released for at least one of the one or more notified active jobs.

6. The method of claim 5, further comprising:
determining that surplus resources are available;
for a particular active job that released resources, determining that a database task associated with the particular active job is not complete;
determining that the particular active job requires additional resources; and
granting the required additional resources to the particular active job.

7. The method of claim 6, further comprising selecting the particular active job to which additional resources are to be granted based on attributes of one or more jobs in the queue of one or more waiting jobs, attributes of one or more jobs in the plurality of active jobs, and the capacity limit for each resource in the minimum number of resources required by the job.

8. The method of claim 1, further comprising storing information identifying the plurality of active jobs that are currently running

9. The method of claim 8, further comprising:
detecting that a system restart has occurred;
retrieving information identifying a plurality of active jobs that were running prior to the system restart;
granting permission, for each job in the plurality of active jobs that were running prior to the system restart, to consume the one or more resources required by the job; and
resuming each job in the plurality of active jobs that were running prior to the system restart.

10. The method of claim 1, wherein notifying an active job that resource permissions have been revoked comprises notifying the active job that permissions for particular resources have been revoked, wherein the active job is able to continue running without using the particular resources.

11. The method of claim 10, wherein the job is not able to complete its associated database task, further comprising placing the job in the queue of one or more jobs waiting to run once the job is no longer able to continue running

12. The method of claim 1, further comprising periodically polling the plurality of active jobs to detect jobs in the plurality of active jobs that are no longer utilizing resources for which they have permission.

13. The method of claim 12, further comprising:
determining that a particular job in the plurality of active jobs is no longer utilizing the resources for which it has permission;
notifying the particular job that permission for the resources that are no longer being utilized has been revoked;
receiving a notification from the particular job that the resources that are no longer being utilized have been released; and
stopping the job.

14. The method of claim 1, further comprising:
receiving a notification that the plurality of resources associated with the one or more computer systems have been re-configured; and
re-assigning resource permissions amongst jobs in the plurality of active jobs.

15. The method of claim 14, further comprising notifying particular jobs in the plurality of active jobs that resource permissions have been revoked.

16. A system for monitoring and managing job resources for database tasks, the system comprising:
a memory associated with one or more computer systems, wherein the one or more computer systems are associated with a plurality of resources, and wherein each resource in the plurality of resources has a capacity limit; and
one or more processors associated with the one or more computer systems, wherein the one or more processors are operable to execute program code embodied on the memory, the program code comprising:
instructions to provide a database, wherein the database is associated with one or more computer systems, wherein the one or more computer systems are associated with a plurality of resources, and wherein each resource in the plurality of resources has a capacity limit;
instructions to monitor a plurality of active jobs, wherein attributes of an active job comprise an associated database task, a priority, a minimum number of resources required by the job, a number of resources currently being consumed by the job, and a length of time that the job has been running;
instructions to select, using one or more processors associated with the one or more computer systems, a job to initiate from a queue of one or more waiting jobs, wherein attributes of a waiting job comprise an associated database task, a priority, a minimum number of resources required by the job, and a length of time that the job has been waiting to start;
instructions to determine, using the one or more processors associated with the one or more computer systems, that one or more resources of the one or more computer systems required by the selected job is not available due to a capacity limit of the at least one resource;
instructions to notify one or more active jobs in the plurality of active jobs that resource permissions have been revoked, wherein the resource permissions are associated with the one or more resources required by the selected job;
instructions to grant permission to the selected job to consume the one or more resources required by the selected job; and
instructions to initiate the selected job.

17. The system of claim 16, the program code further comprising instructions to determine that a particular job from the queue of one or more waiting jobs should be selected for initiation based on attributes of one or more jobs in the queue of one or more waiting jobs, attributes of one or more jobs in the plurality of active jobs, and the capacity limit for each resource in the minimum number of resources required by the job.

18. The system of claim 16, the program code further comprising instructions to determine that resource permissions for a particular active job should be revoked based on attributes of one or more jobs in the queue of one or more waiting jobs, attributes of one or more jobs in the plurality of active jobs, and the capacity limit for each resource in the minimum number of resources required by the job.

19-30. (canceled)

31. A non-transitory machine-readable storage medium with instructions for monitoring and managing job resources for database tasks tangibly embodied therein, the instructions comprising:
instructions to provide a database, wherein the database is associated with one or more computer systems, wherein the one or more computer systems are associated with a plurality of resources, and wherein each resource in the plurality of resources has a capacity limit;
instructions to monitor a plurality of active jobs, wherein attributes of an active job comprise an associated database task, a priority, a minimum number of resources required by the job, a number of resources currently being consumed by the job, and a length of time that the job has been running;
instructions to select, using one or more processors associated with the one or more computer systems, a job to initiate from a queue of one or more waiting jobs, wherein attributes of a waiting job comprise an associated database task, a priority, a minimum number of resources required by the job, and a length of time that the job has been waiting to start;
instructions to determine, using the one or more processors associated with the one or more computer systems, that one or more resources of the one or more computer systems required by the selected job is not available due to a capacity limit of the at least one resource;
instructions to notify one or more active jobs in the plurality of active jobs that resource permissions have been revoked, wherein the resource permissions are associated with the one or more resources required by the selected job;
instructions to grant permission to the selected job to consume the one or more resources required by the selected job; and
instructions to initiate the selected job.

32. The non-transitory machine-readable storage medium of claim 31, the program code further comprising instructions to interrupt at least one of the one or more active jobs in the plurality of active jobs so that resources associated with the permissions can be released.

33. The non-transitory machine-readable storage medium of claim 31, the program code further comprising instructions to determine that resources have been released for at least one of the one or more notified active jobs.

34-45. (canceled)
